(19) United States
(12) Patent Application Publication
(10) Pub. No.: US 2017/0349042 A1
(43) Pub. Date: Dec. 7, 2017

(54) UNIVERSAL WHEEL

(71) Applicants: CHUN-HSIANG YANG, Taipei City (TW); Hsiu-Fang Chang, Taipei City (TW)

(72) Inventors: CHUN-HSIANG YANG, Taipei City (TW); Hsiu-Fang Chang, Taipei City (TW)

(21) Appl. No.: 15/173,617

(22) Filed: Jun. 4, 2016

(51) Int. Cl. B60K 7/00; B62D 5/04

(52) U.S. Cl. CPC B60K 7/0007; B62D 5/0418; B60K 2007/0084; B60K 2007/003; B60K 2007/0092

(57) ABSTRACT

The universal wheel includes a base member, a connection member, a wheel member, a first driving element, and a second driving element. The connection member has a first end fixed to a top side of the base member. The wheel member is rotatably joined to the base member. The first driving element is configured on the base member for rotating the base member laterally within 360 degrees. The second driving element is for rotating the wheel member. The universal wheel can be turned 360 degrees when standing in place, and can be moved forward, laterally, slantwise, rotationally, or in a combination of these operations.

### BACKGROUND OF THE INVENTION

### (a) Technical Field of the Invention

The present invention is generally related to universal wheels, and more particular to a universal wheel driven by two driving elements so that the wheel provides movements toward various directions around 360 degrees.

### (b) Description of the Prior Art

When a wheel on a vehicle or other device is turned, the vehicle or the device usually can only move forward or backward, and cannot spin in place.

For example, for curbside parking, a driver of the vehicle should have certain skill and experience to operate the vehicle so as to avoid scratch or collision to the vehicle. There are universal wheels that can be turned in place within 360 degrees, but these universal wheels usually involve a number of wheel members and as such are complicated and costly.

### SUMMARY OF THE INVENTION

Therefore, the present invention teaches a universal wheel that can be turned 360 degrees when standing in place, and can be moved forward, laterally, slantwise, rotationally, or in a combination of these operations.

The universal wheel includes a base member, a connection member, a wheel member, a first driving element, and a second driving element. The connection member has a first end fixed to a top side of the base member. The wheel member is rotatably joined to the base member. The first driving element is configured on the base member for rotating the base member laterally within 360 degrees. The second driving element is coupled to the wheel member for rotating the wheel member.

The first end of the connection member is threaded through the top side of the base member and joined to a first fastening element so that the first end of the connection member is fixed to a bottom face of the top side of the base member.

The first end of the connection member is configured with flange segments for locking with the first fastening element.

A second end of the connection member is threaded through a second fastening element, and the first driving element engages the second fastening element so that the base member is rotatable laterally.

The first driving element is a motor.

The second driving element engages an axle of the wheel member so that the wheel member is turned clockwise or counterclockwise around the axle.

The second driving element is a motor.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a universal wheel according to an embodiment of the present invention.

FIG. 2 is a perspective break-down diagram showing the universal wheel of FIG. 1.

FIG. 3 is a schematic diagram showing an operation scenario of the universal wheel of FIG. 1 when a first driving element is functioning.

FIG. 4 is a schematic diagram showing another operation scenario of the universal wheel of FIG. 1 when a second driving element is functioning.

FIG. 5 is a perspective diagram showing the universal wheel of FIG. 1 remotely controlled via wires.

FIG. 6 is a schematic diagram showing a universal wheel of the present invention implemented on a vehicle.

FIG. 7 is a perspective diagram showing a universal wheel according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

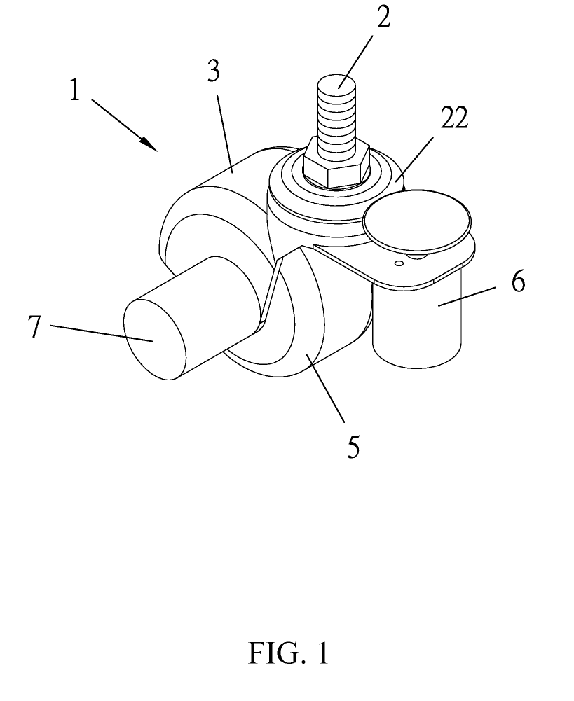

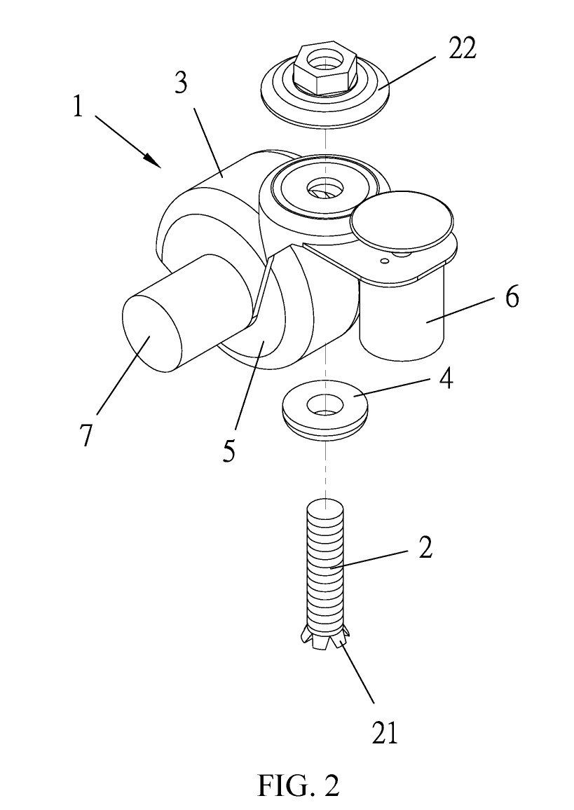

As shown in FIGS. 1 and 2, a universal wheel 1 according to an embodiment of the present invention includes a connection member 2, a base member 3, and a wheel member 5. A first end of the connection member 2 is threaded through a top side of the base member 3 and joined to a first fastening element 4 so that the first end of the connection member 2 is fixed to a bottom face of the top side of the base member 3. The first end of the connection member 2 is configured with flange segments 21 for locking with the first fastening element 4. A second end of the connection member is threaded through a second fastening element 22. The base member 3 has a pair of downward extended and parallel side pieces (not numbered) between which the wheel member is pin-joined. A first driving element 6 is configured on the base member 3, engaging the second fastening element 22 so that the base member 3 is rotatable laterally for 360 degrees. On the other hand, a second driving element 7 is configured on one of the side pieces, engaging an axle (not shown) of the wheel member 5 so that the wheel member 5 is rotatable around the axle. The first and second driving elements 6 and 7 are motors in the present embodiment.

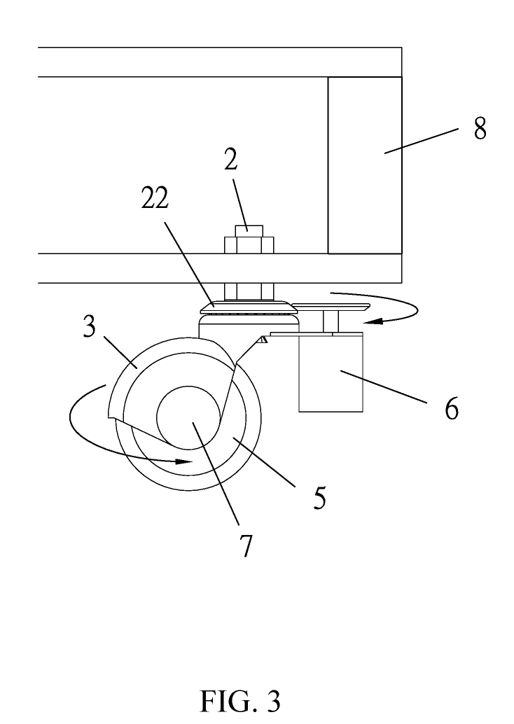

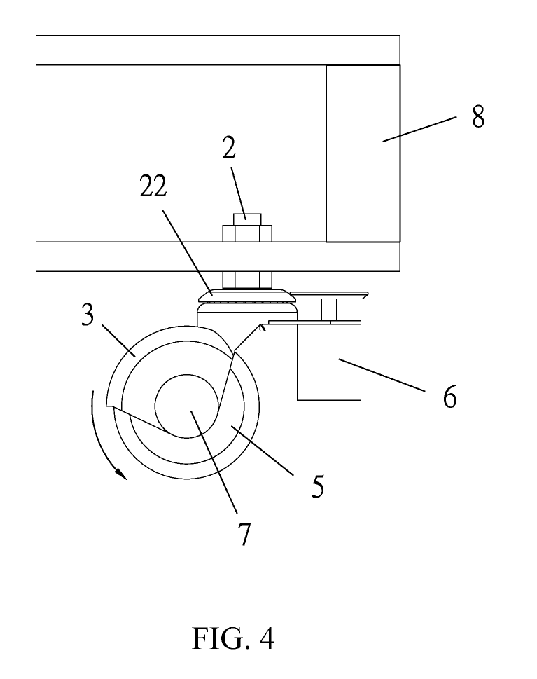

As shown in FIGS. 3 and 4, the connection member 2 is for mounting the universal wheel 1 to a bottom side of an object 8. When the object 8 is moved, the first driving element 6 is able to turn the base member 3 around for 360 degrees and the object 8 is therefore can be moved toward any direction. In the meantime, the second driving element 7 is able to turn the wheel member 5 clockwise or counterclockwise so that the object 8 can be moved forward or backward. Therefore, through the first and second driving elements 6 and 7, the object 8 can be moved forward or backward along various directions and the moving direction can be altered easily. In other words, the object 8 can be turned 360 degrees when standing in place, and the object 8 can be moved forward, laterally, slantwise, rotationally, or in a combination of these operations.

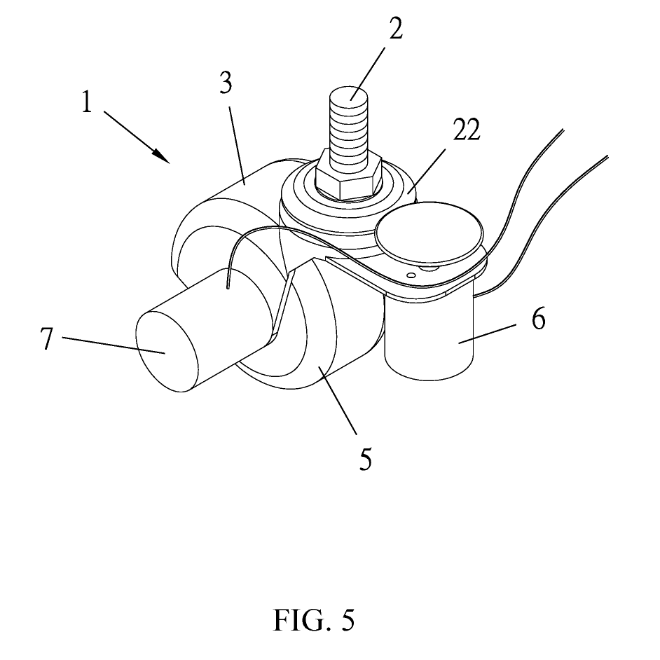

As shown in FIG. 5, the first and second driving elements 6 and 7 can be controlled remotely through sensors or manual operation.

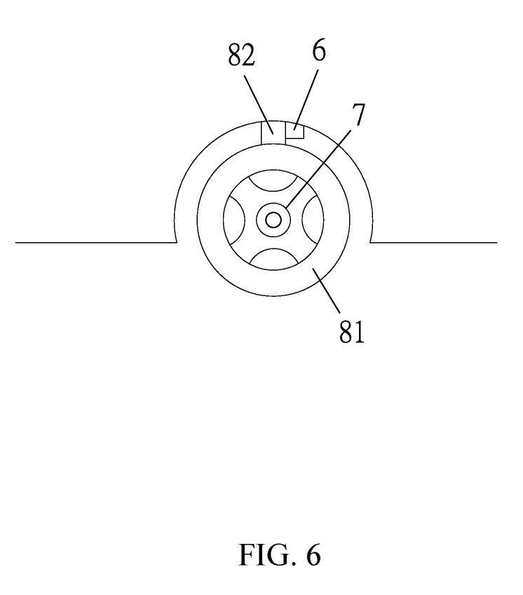

As shown in FIG. 6, the universal wheel 1 is installed on a vehicle along with a vehicle wheel member 81. The first driving element 6 is configured on an axle 82 of the vehicle wheel member 81. The first driving element 6 engages the axle 82 so as to turn the vehicle wheel member 81 and the vehicle wheel member 81 can be rotated laterally for 360 degrees. The second driving element 7 is coupled to the vehicle wheel member 81 so that, when the vehicle cannot be started, the vehicle can still be moved forward or backward through the second driving element 7. A user is therefore not required to push the vehicle when the vehicle cannot be started.

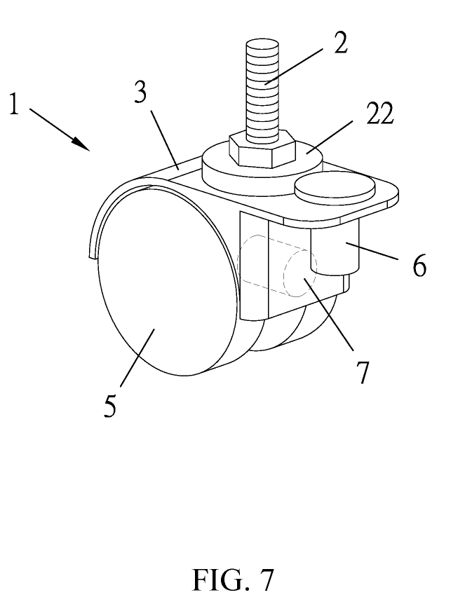

As shown in FIG. 7, a universal wheel 1 according to another embodiment of the present invention also has the first driving element 6 to turn the base member 3 laterally around 360 degrees, and the second driving element 7 to engage an axle (not shown) of the wheel member 5 to turn the wheel member 5 clockwise or counterclockwise.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

1. A universal wheel, comprising
a base member;
a connection member having a first end fixed to a top side of the base member;
a wheel member rotatably joined to the base member;
a first driving element configured on and engaging the base member for rotating the base member laterally within 360 degrees; and
a second driving element directly connected to an axle of the wheel member and engaging the axle to turn clockwise or counterclockwise for rotating the wheel member.

2. The universal wheel according to claim 1, wherein the first end of the connection member is threaded through the top side of the base member and joined to a first fastening element so that the first end of the connection member is fixed to a bottom face of the top side of the base member.

3. The universal wheel according to claim 2, wherein the first end of the connection member is configured with flange segments for locking with the first fastening element.

4. The universal wheel according to claim 1, wherein a second end of the connection member is threaded through a second fastening element; and the first driving element engages the second fastening element so that the base member is rotatable laterally.

5. The universal wheel according to claim 4, wherein the first driving element is a motor.

6. (canceled)

7. The universal wheel according to claim 1, wherein the second driving element is a motor.
